(19) United States
(12) Patent Application Publication
(10) Pub. No.: US 2012/0133835 A1
(43) Pub. Date: May 31, 2012

(54) SELECTIVE COMPENSATION FOR AGE-RELATED NON UNIFORMITIES IN DISPLAY

(75) Inventors: Franciscus Hendrikus Van Heesch, Eindhoven (NL); Michiel Adriaanszoon Klompenhouwer, Eindhoven (NL); Oleg Belik, Eindhoven (NL)

(73) Assignee: KONINKLIJKE PHILIPS ELECTRONICS N.V., EINDHOVEN (NL)

(21) Appl. No.: 13/389,079

(22) PCT Filed: Aug. 5, 2010
(86) PCT No.: PCT/IB2010/053547

§ 371 Date: Feb. 6, 2012

(30) Foreign Application Priority Data
Aug. 11, 2009 (EP) 09305746.1

(51) Int. Cl. H04N 5/14

(52) U.S. Cl. 348/576; 348/E05.066; 348/E05.077

(57) ABSTRACT

A video signal compensator (10, 70, 80, 290) for selectively compensating for age-related non-uniformities in a display, receives an indication of motion or detects motion in an incoming video signal, and receives or determines an indication of amounts of compensation for the different parts of the display needed to compensate for the non-uniformities. The compensator selectively applies the needed amount of compensation to the video signal according to the indicated motion to apply less of the needed compensation where there is less motion, over at least some of the range of possible motions. This can reduce the drive levels at least where the non uniformities are less visible because of the motion in the video. The reduced drive levels can lead to less ageing and thus prolong display life. The amounts of needed compensation can be predicted or determined from measured outputs of pixels of the display.

### BACKGROUND OF THE INVENTION

The present invention relates to apparatus and methods for compensating for age related non-uniformities in a display, and to corresponding display driver circuits, integrated circuits display systems and computer programs.

Displays with individual light sources per (sub)-pixel, such as LED, plasma panels and OLED displays often suffer from differential aging of individual light sources, resulting in visible non-uniformities. To counteract differential aging, compensation methods have been disclosed that attempt to restore luminance uniformity. Preferably, these displays contain some form of uniformity compensation to counteract these non-uniformities. The disadvantage of these compensation techniques is the acceleration of differential aging and as a result a further reduction of the lifetime of the display.

US 2008106649 shows a video processor which can make use of motion estimation, in this case for burn-in control. The video processor intelligently recognizes aspects of a video image that are likely to cause burn-in, and responsive to such recognition, modifies the video image to prevent uneven aging of the pixels. According to one aspect, modifications are spatially made to an entire video frame, one or more selected regions of a video frame, or one or more individual pixels of a video frame. According to another aspect of the disclosure, modifications are temporally made to all frames in a video stream, selected frames in a video stream, or a single frame in a video stream.

### SUMMARY OF THE INVENTION

An object of the invention is to provide alternative apparatus and methods for compensating for age related non-uniformities in a display, and to provide corresponding display driver circuits, integrated circuits display systems and computer programs. According to a first aspect, the invention provides:

A video signal compensator for selectively compensating for age-related non-uniformities in a display, the compensator having an input arranged to receive an indication of motion in an incoming video signal, and an input arranged to receive an indication of amounts of compensation for the different parts of the display needed to compensate for the non-uniformities, the compensator being arranged to selectively apply the needed amount of compensation to the video signal according to the indicated motion.

Since visibility of non uniformities varies with motion, whereby typically non-uniformities are more visible when there is more motion, so compensation can be reduced selectively to reduce drive levels at least where the non uniformities are less visible because of the motion in the video. The reduced drive levels can lead to less ageing and thus prolong display life. This approach contrasts with burn in control which aims to prevent the differential ageing by altering the video content. Instead, the present approach is concerned with improving the compensation after such differential ageing has happened.

Other aspects can involve a display driver circuit having a pixel drive circuit for each pixel, and a compensator for each pixel drive circuit.

Other aspects can involve a display system having a display panel and the compensator, or the driver circuit.

Another aspect provides a corresponding method of selectively compensating for age-related non-uniformities in a display, the method having the steps of receiving an indication of motion in an incoming video signal, receiving an indication of amounts of compensation for the different parts of the display needed to compensate for the non-uniformities, and selectively applying the needed amounts of compensation to the video signal according to the indicated motion.

Another aspect involves a computer program product comprising code segments, which when executed on a processing engine implement any of the methods of selectively compensating for age-related non-uniformities. Another aspect provides a machine readable signal storage medium having the computer program product stored thereon. Another aspect provides an integrated circuit having the compensator.

Embodiments of the invention can have any other features added, some such additional features are set out in dependent claims and described in more detail below.

Embodiments can have any additional features, any of the additional features can be combined together and combined with any of the aspects. Other advantages will be apparent to those skilled in the art, especially over other prior art. Numerous variations and modifications can be made without departing from the claims of the present invention. Therefore, it should be clearly understood that the form of the present invention is illustrative only and is not intended to limit the scope of the present invention.

### BRIEF DESCRIPTION OF THE DRAWINGS

How the present invention may be put into effect will now be described by way of example with reference to the appended drawings, in which:

FIG. 1 shows a schematic view of apparatus according to a first embodiment,

FIG. 2 shows a schematic view according to another embodiment,

FIG. 3 shows method steps according to an embodiment,

FIG. 4 shows a schematic view of an embodiment using actual ageing rather than predicted ageing,

FIG. 5 shows a schematic view of an embodiment having compensation according to spatial variability, and

FIG. 6 shows a schematic view of an embodiment of a display panel having a compensator for each pixel driver.

FIG. 7 shows a schematic processing engine that can be used with the present invention.

### DETAILED DESCRIPTION OF THE EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. Where the term “comprising” is used in the present description and claims, it does not exclude other elements or steps. Where an indefinite or definite article is used when referring to a singular noun e.g. “a” or “an”, “the”, this includes a plural of that noun unless something else is specifically stated.

The term “comprising”, used in the claims, should not be interpreted as being restricted to the means listed thereafter; it does not exclude other elements or steps. Thus, the scope of the expression “a device comprising means A and B” should not be limited to devices consisting only of components A and B. It means that with respect to the present invention, the only relevant components of the device are A and B.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention. References to a signal can encompass any kind of signal in any medium, and so can encompass an electrical or optical or wireless signal or other signal for example. References to a processor can encompass any means for processing signals or data in any form and so can encompass for example a personal computer, a microprocessor, analog circuitry, application specific integrated circuits, software for the same, and so on.

In the description provided herein, numerous specific details are set forth. However, it is understood that embodiments of the invention may be practiced without these specific details. In other instances, well-known methods, structures and techniques have not been shown in detail in order not to obscure an understanding of this description.

According to embodiments of the invention, the acceleration of the differential aging, caused by the differential aging compensation methods themselves, can be reduced by applying the differential aging compensation only when non-uniformities are visible. This reduces the effective amount of differential aging compensation without increasing visible non-uniformities, This can therefore increase the life time of the display. It is based on an appreciation that the visibility of display non-uniformities depends on the portrayed content. It depends on contrast and the spectral energy distribution, but also on the apparent motion.

Differential aging compensation methods adjust the video intensities that are to be displayed to correct for local deviations of the display's electro-optical transfer function. The compensation can be done separately for each colour of a display. In some cases, a feedback system is used that measures the actual local light output. Embodiments of the invention can control the amount of compensation based on the apparent motion in the video signal. For this a motion estimator can be used. An example of a motion estimator is shown in “Sub-pixel motion estimation with 3-d recursive search block-matching,” in Signal Processing: Image Communication, Vol. 6, pp. 229-239, 1994 by G. de Haan and P. W. A. C. Biezen. The embodiments can be applied to any kind of displays that suffer from differential ageing. Especially, displays that have a short lifetime, such as OLEDs can benefit from this method, but it applies to all displays that have multiple light sources, e.g. LED displays and scanning/local dimming backlights. It is most interesting for domains where displays portray motion, such as TV applications.

Embodiments can have any additional features, additional to selectively applying the needed amount of compensation to the video signal according to the indicated motion. Some such additional features are set out in dependent claims and described in more detail below. One such feature is the compensator being arranged to apply less of the needed compensation where there is less motion, over at least some of the range of possible motions. This can help optimise compensation according to visibility.

Another such feature is to incorporate a motion detector for generating the indication of motion. This can enable the motion detection to be tailored to the needs of the compensator. Another such feature is the indication of motion indicating motion per pixel or per group of pixels. This can distinguish between ‘global motion detection’ and ‘local motion estimation’. This can be better than indicating full frame motion since compensation can be tailored to different motion in different parts of a frame.

Another such additional feature is a part for generating the indication of amounts of needed compensation. This can result in a more complete, self contained system, though in principle this indication could be provided from external source e.g. a centralised manufacturer database coupled by internet. In principle, the compensation depends on what content has been displayed in the past, and on the particular display (pixel-to-pixel variation), so obtaining the amounts of needed compensation from an external source is not a preferred solution.

The part for generating the indication of amounts of needed compensation can comprise a store for storing for each pixel initial characteristics of the pixel and an accumulation of video levels experienced over the life of the display, and for deriving the indication according to the accumulation and according to a model of display output ageing for various accumulations and pixel characteristics. The model that can estimate the required compensation, as a function of accumulated pixel intesities, can also require or at least benefit from some pixel characteistics (threshold voltage, etc) that can vary from pixel to pixel, and that can be determined before the display is used in an initial calibration step.

This can avoid the need to detect actual light output of the display and hence be compatible with existing displays, or keep the display construction simpler and thus more cost effective.

Alternatively (or as well), the part for generating the indication of amounts of needed compensation can comprise an output detector for determining a light output of each pixel, and for generating the indication according to the light output. This can provide more accurate indications than predicting by accumulating and modelling of the ageing, but involves a more complex display construction.

Another additional feature is the compensator having a part for determining a level of spatial variability in a given frame of the incoming video signal and the compensator being arranged to selectively apply the needed amount of compensation to the video signal according to the determined level of spatial variation. As visibility of non uniformities also varies with spatial variability, where typically on-uniformties are more visible when there is less spatial variation, so this can further reduce the compensation and thus reduce drive levels and so prolong display life.

The compensator can be arranged to output a compensated video signal representing each pixel sequentially in time for feeding to a display driver, to enable operation with a conventional display. Alternatively, the compensation can be carried out off-line on stored video signals, but only when these stored signals are going to be displayed on the intended display.

The compensator can be incorporated in a display driver circuit or a pixel drive circuit for each pixel, in which case a compensator may be provided for each pixel drive circuit. There is typically only one display driver circuit per panel e.g. in the form of a ‘timing controller’, or ‘video processor’, or one per (set of) pixel columns, e.g. in the form of a data driver.

A pixel drive circuit is a circuit that is present in each pixel, and therefore is simpler than the data driver or timing controller. Compensation in both places is included within the scope of the present invention.

These circuits can enable closer integration of compensation to the source of the non uniformity being compensated, and avoid needing to add the compensator to the video processor. But this adds complexity and therefore costs to the display. A display system can be provided having a display panel and the compensator, or the display driver circuit.

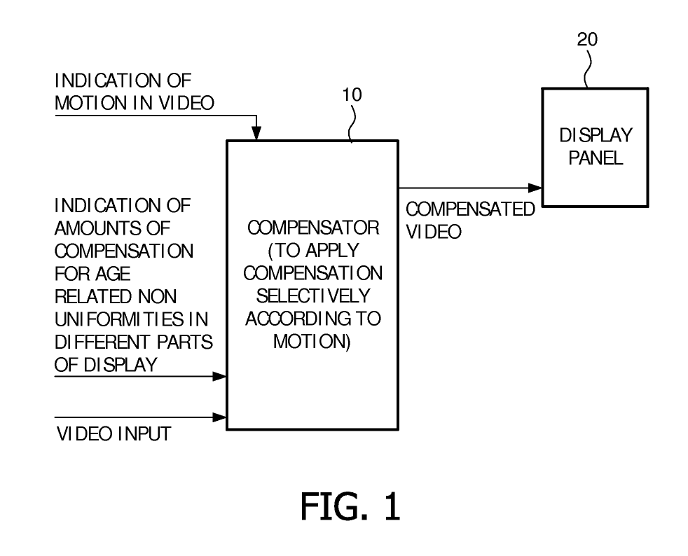

A schematic view of a first embodiment is shown in FIG. 1. A compensator 20 receives a video input and outputs a compensated video signal to a display panel 10. The compensator also receives input signals indicating an amount of motion in the video input and an indication of amounts of compensation for age related non uniformities in different parts of the display. The compensator is operable to apply compensation selectively according to the indicated amount of motion. As the visibility of non uniformities varies with motion, thus the compensation can be reduced during motion, which means reduced drive levels and this can prolong display panel lifetime. The compensator can be implemented in many different ways and be located either with the display or as a separate unit for example. The compensator can be arranged to operate in real time in which case the video input can be a real time video signal. Or the compensator can operate off line, not in real time, and the video input can be data representing frames of the video arriving at a rate not related to a frame rate.

The compensator can be arranged to apply less of the needed compensation where there is less motion, over at least some of the range of possible motions. This can help optimise compensation according to visibility of the non uniformities. The amount of motion can be determined by a motion detector for generating the indication of motion. This can enable the motion detection to be tailored to the needs of the compensator for example. In some cases the indication of motion can indicate motion per pixel or per group of pixels. This can be better than full frame motion since it can mean the compensation can be tailored to different motion in different parts of the frame.

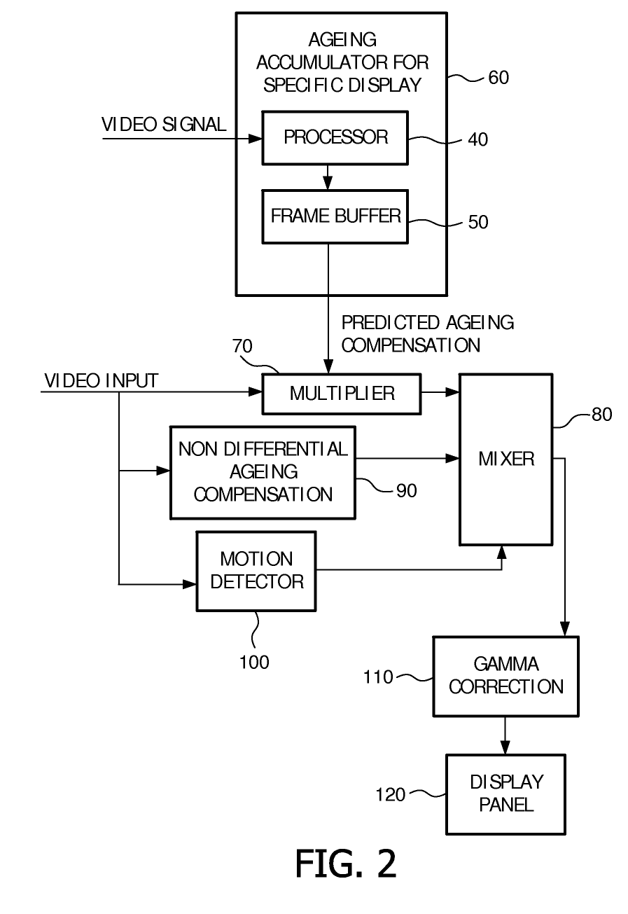

FIG. 2 shows an embodiment of a compensator having the indication of amounts of compensation for age related non uniformities in different parts of the display in the form of predicted ageing compensation. A predicted ageing compensation signal for a particular display is generated from a model based on the history of signals used to drive that particular display over its lifetime, and on the pixel characteristics. This can be determined by an ageing accumulator part 60 for that specific display. This can be implemented by a processor 40 arranged to receive the input video signal and record in a frame buffer 50 of non volatile memory a record representing an accumulation of all the drive signals for each pixel or group of pixels over the lifetime of the display panel.

This frame buffer can output a signal synchronised with the input video signal in the form of a compensation factor which varies for each pixel or group of pixels, suitable to multiply the input video signal. This can produce what might be called a differentially compensated video signal, in the sense that different pixels have different amounts of ageing compensation. A multiplier 70 is provided for this multiplication. This can be in the form of a look up table or other conventional digital or analog circuitry as desired. An output of the multiplier is fed to a mixer 80. This mixes the specific predicted differential age compensated signal with a uniformly compensated (non differential) compensation signal provided by part 90. The mixer operates to output either the differentially compensated signal or the non differentially compensated signal, or a mixed signal having a controllable proportion of each, according to the amount of motion in the input video signal. The mixed signal is fed to a display panel 120, typically through a conventional gamma correction part 110, typically implemented as a look up table.

The amount of motion can be detected by a motion detector 100. This can be implemented in various ways following conventional practice. Note there is no need to detect a direction of the motion, in other words a motion vector, as the visibility of the non uniformities is not usually dependent on the direction of the motion. So only the amount of motion needs to be detected. This can be detected by comparison to the preceding frame or frames and can be detected over a small 3×3 pixel block or over a wider region for example. The mixer can be arranged to provide full compensation where there is no motion, and a decreasing amount of compensation as more motion is detected. In a typical implementation the motion signal is an 8-bit digital signal at sub-pixel rate. The entire compensator can be implemented in digital circuitry such as an ASIC or FPGA circuitry.

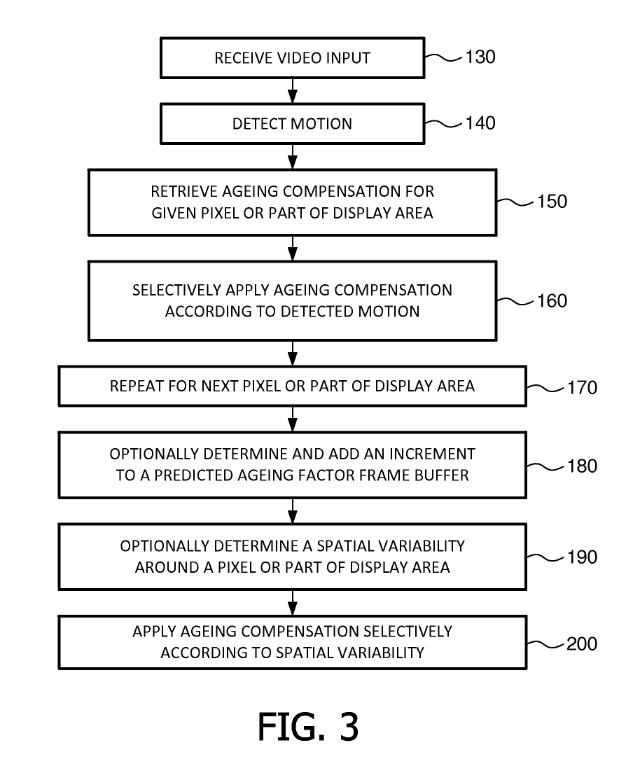

FIG. 3 shows steps in the operation of the embodiment of FIG. 2, or other embodiments. At step 130, video is received. At step 140, motion in the video is detected. At step 150 ageing compensation for a given pixel or part of a display area is retrieved. At step 160, the ageing compensation is selectively applied to the input video according to the detected motion. This is repeated for a next pixel or for a next part of the display area, as shown by step 170. Optionally at step 180, a predicted ageing factor frame buffer is updated by determining and adding an increment into the appropriate part of the frame buffer, to represent how much that pixel has been driven over the life of the display, and therefore how much it would have aged and thus how much its output would have changed. Optionally as shown at step 190, a spatial variability of the video signal is determined around a pixel or part of the display area. The ageing compensation can be applied selectively according to the spatial variability as well as according to the motion as per step 200. This can further reduce the amount of compensation applied and therefore further increase the lifetime of the display. This benefit can be achieved without affecting the visibility of the non uniformities too much, in so far as the non uniformities are less visible when there is more spatial variation. Different amounts of compensation can be applied to different colours as the ageing is likely to be different for different colours and the visibility is likely to be different.

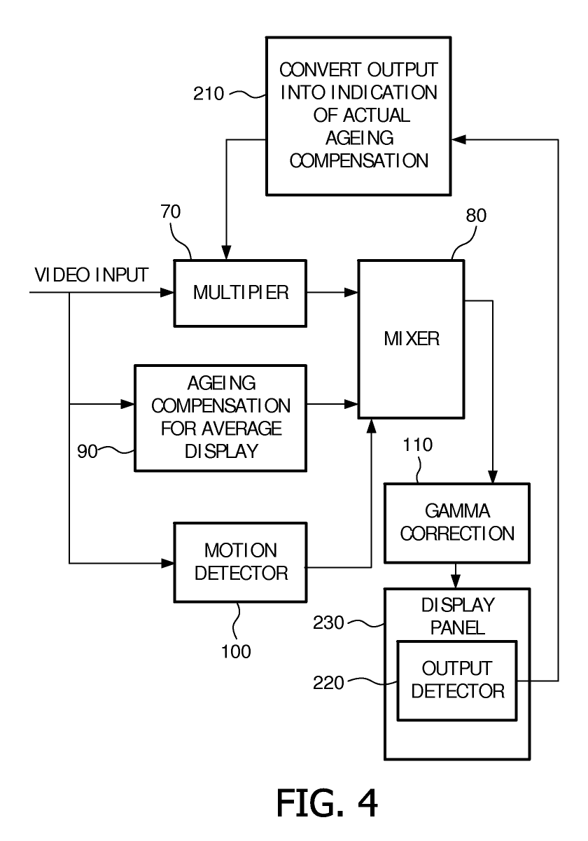

FIG. 4 shows an embodiment using actual ageing rather than predicted ageing. This shows some similar parts to those of FIG. 2, and corresponding reference numerals have been used as appropriate, and reference is made to the description of such parts of FIG. 2. Instead of the ageing accumulator part 60 for the specific display, there is an actual ageing factor for each pixel or part of the display input to the multiplier 70. This can be generated by an output detector 220 in the display panel 230, and a part 210 for converting the output into an indication of actual ageing compensation needed. The output detector can detect light output if it is in the optical output path of the display or the particular pixel of the display, or it can detect output indirectly. For example in some cases a value of resistance or current flow in a pixel drive circuit can indicate the light output and thus indicate the ageing of that pixel. The part for converting can be implemented using conventional circuit elements and can convert the detected output by comparing it to an expected or reference value for the given video input level or given pixel drive level after gamma correction for that pixel for example.

In cases where the output detector detects light output, it can be built into the display or can be an external part such as a video camera pointing at the display for example.

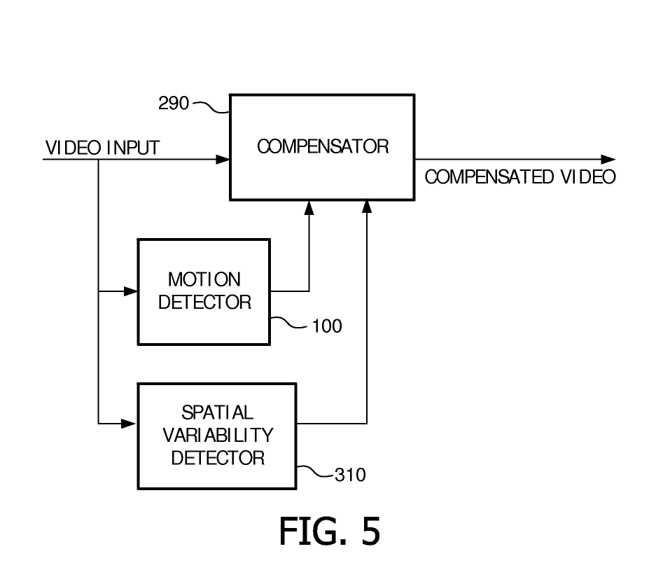

FIG. 5 shows a schematic view of another embodiment showing a compensator 290, a motion detector 100, and a spatial variability detector 310. The compensator receives a video input and outputs a compensated video output, compensated for age-related non uniformities in the display. The compensation is selective according to the motion detected, and according to the spatial variability. Non uniformities may be most visible when there are small changes in spatial variability and a small amount of motion, such as a scene of clouds moving across a sky. Thus compensation could be at a maximum for such cases. Where there is no motion or fast motion, the non uniformities are less visible and so differential compensation can be progressively reduced. Of course any non differential compensation should not be reduced. Any compensation for non-linear electro-optic characteristics is preferably always applied. Further, a compensation for non-ageing related pixel-to-pixel variations (i.e. as present directly after manufacturing) can be treated in the same way as ageing related variations. It is the total pixel-to-pixel variation that counts.

To avoid sharp transitions between pixels or regions where compensation is reduced, there could be a spatial smoothing of the mixing. This could be provided regardless of whether the mixing is based on motion or motion and spatial variation. It could be achieved by providing a number of line buffers storing the proportions used for mixing for each of the pixels in the last few lines. Then the mixing of a current pixel can be controlled according to the proportions used in the pixels above and to the sides of the current pixel.

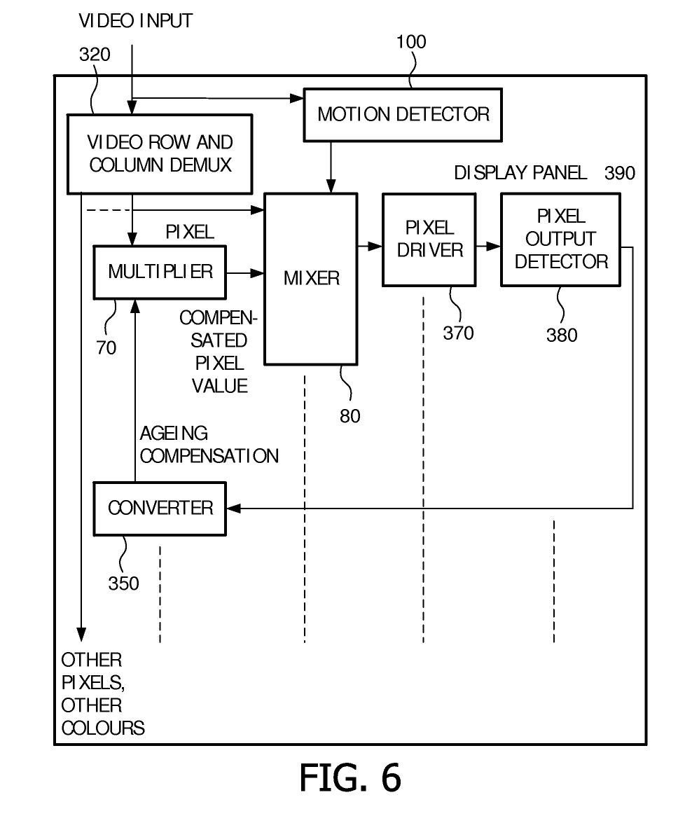

FIG. 6 shows a schematic view of an embodiment of a display panel having a compensator incorporated with each pixel driver. A video input is fed to a video row and column demultiplexer 320 and to a motion detector 100. The demultiplexer outputs individual pixel signals for each frame. These are each fed to individual pixel drivers 370 via new circuitry for achieving the compensation. This includes a pixel multiplier 70 for each pixel and a mixer 80 for each pixel, and a pixel output detector 380. A convertor 350 is shown for converting the output into an ageing compensation factor. As in other embodiments, the multiplier is used to multiply the pixel value by the ageing factor. Again the mixer is used to determine how much compensation is applied according to the motion detected for that pixel or region of the display. The motion detector can be a common one for all pixels, generating a continuous signal which can be passed to all pixels and time gated at each pixel driver to determine a motion value for each pixel. As before, the mixer can be arranged to make the proportions of compensated and uncompensated values in the signal output to the pixel driver in a linear relationship to the amount of motion. Alternatively it can be a more complex control to provide a closer relationship to the visibility of the non uniformities, for example by having some compensation where there is no motion, most compensation when there is slow motion, such as a slow panning video sequence and no compensation when there is relatively fast motion.

In this case the video input may already have some compensation applied before it reaches the display panel, for gamma correction and for non differential ageing compensation for example.

There may be separate drive circuitry for each colour for each pixel, and each may have its own mixer, converter and multiplier. As there are so many pixels, there will typically be a great cost benefit in keeping this circuitry as simple as possible. So the multiplier and mixer could be implemented as analog circuits integrated with the pixel driver circuitry 370 for example. Alternatively, in principle, instead of distributing the compensators to operate in parallel at each of the pixel drivers, a “centralized” or serial arrangement could be provided by having a single mixer and multiplier before the video row and column demultiplexer part 320. But if individual pixel output detectors are provided for each pixel, such a solution would need much multiplexing circuitry to time division multiplex all the output detections into a common converter.

As has been described above, embodiments can involve an image conversion unit for converting an input image to an output image where the output image portrays the input image by compensating drive values for the visibility of local differences in the electro-optical transfer function. The local differences in the electro-optical transfer function can be compensated using the apparent motion in video to determine the visibility of the differences.

Although, the present invention may be implemented in hardware circuits, some parts can be implemented in software in any computer language, run by conventional processing hardware such as a general purpose microprocessor, or application specific integrated circuits for example.

For example, the compensator according to embodiments of the present invention may be implemented as hardware, computer software, or combinations of both. The compensator may include a general purpose processor, an embedded processor, an application specific integrated circuit (ASIC), a field programmable gate array (FPGA) or other programmable logic device, discrete gate or transistor logic, discrete hardware components, or any combination designed to perform the functions described herein. A processor may also be implemented as a combination of computing devices, e.g., a combination of an FPGA and a microprocessor, a plurality of microprocessors, one or more microprocessors in conjunction with an FPGA, or any other such configuration.

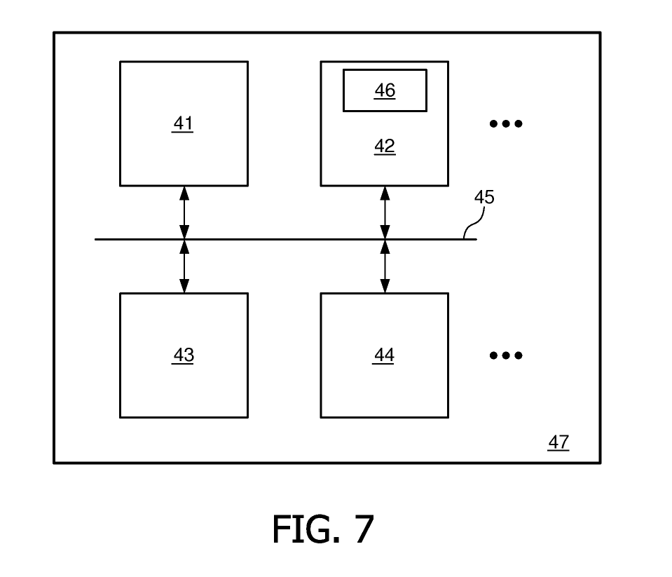

As indicated above the present invention also provides a processor system for use in the present invention. The processing system may include a computing device or processing engine, e.g. a microprocessor. Any of the methods described above according to embodiments of the present invention or claimed may be implemented in a processing system 47 such as shown in FIG. 7. FIG. 7 shows one configuration of processing system 47 that includes at least one customisable or programmable processor 41 coupled to a memory subsystem 42 that includes at least one form of memory, e.g., RAM, ROM, and so forth. It is to be noted that the processor 41 or processors may be a general purpose, or a special purpose processor, and may be for inclusion in a device, e.g. a chip that has other components that perform other functions. Thus, one or more aspects of the method according to embodiments of the present invention can be implemented in digital electronic circuitry, or in computer hardware, firmware, software, or in combinations of them. The processing system may include a storage subsystem 43 that has solid state memory or a disk drive and/or a port for a solid state memory such as a USB connected memory. In some implementations, a display system, a keyboard, and a pointing device may be included as part of a user interface subsystem 44 to provide for a user to manually input information, such as parameter values. The various elements of the processing system 47 may be coupled in various ways, including via a bus subsystem 45 shown in FIG. 7 for simplicity as a single bus, but which will be understood to those in the art to include a system of at least one bus. The memory of the memory subsystem 42 may at some time hold part or all (in either case shown as 46) of a set of instructions that when executed on the processing system 47 implement the steps of the method embodiments described herein.

The present invention also includes a computer program product which provides the functionality of any of the methods according to the present invention when executed on a computing device. The computer program product according to the present invention comprises software which, when executed on a processing engine, provides a video signal compensator for selectively compensating for age-related non-uniformities in a display, the software for the compensator including code segments that when executed on a processing engine allow receipt of an indication of motion in an incoming video signal, as well as to receive an indication of amounts of compensation for the different parts of the display needed to compensate for the non-uniformities. The software is preferably adapted to selectively apply the needed amount of compensation to the video signal according to the indicated motion.

The software may be adapted to apply less of the needed compensation where there is less motion, over at least some of the range of possible motions.

The software may be arranged to provide motion detection for generating the indication of motion. The software may be adapted to detect motion of an object in an image, by selecting part of the image having the object and detecting motion of that part compared to a preceding image.

The software may be adapted to provide the indication of motion as an indicator of motion per pixel or per group of pixels.

The software may be adapted to generate the indication of amounts of needed compensation.

The software may be adapted to generate the indication of amounts of needed compensation by storing for each pixel an accumulation of video levels experienced over the life of the display, and deriving the indication according to the accumulation and according to a model of display output ageing for various accumulations.

The software may be adapted to generate the indication of amounts of needed compensation by determining a light output of each pixel, and then generating the indication according to the light output.

The software may be adapted to determine a level of spatial variability in a given frame of the incoming video signal and to selectively apply the needed amount of compensation to the video signal according to the determined level of spatial variation.

The software may be adapted to output a compensated video signal representing each pixel sequentially in time for feeding to a display driver.

Such a computer program product can be tangibly embodied in a carrier medium carrying machine-readable code for execution by a programmable processor. The present invention thus relates to a carrier medium carrying a computer program product that, when executed on computing means, provides instructions for executing any of the methods as described above. The term “carrier medium” refers to any medium that participates in providing instructions to a processor for execution such as any machine readable signal storage medium. Such a medium may take many forms, including but not limited to, non-volatile media, and transmission media. Non-volatile media includes, for example, optical or magnetic disks, such as a storage device which is part of mass storage. Common forms of computer readable media include, a CD-ROM, a DVD, a flexible disk or floppy disk, a tape, a memory chip or cartridge or any other medium from which a computer can read. Various forms of computer readable media may be involved in carrying one or more sequences of one or more instructions to a processor for execution. The computer program product can also be transmitted via a carrier wave in a network, such as a LAN, a WAN or the Internet. Transmission media can take the form of acoustic or light waves, such as those generated during radio wave and infrared data communications. Transmission media include coaxial cables, copper wire and fibre optics, including the wires that comprise a bus within a computer.

Other variations can be envisaged within the claims.

1. A video signal compensator for selectively compensating for age-related non-uniformities in a display, the compensator having an input arranged to receive an indication of motion in an incoming video signal, and an input arranged to receive an indication of amounts of compensation for the different parts of the display needed to compensate for the non-uniformities, the compensator being arranged to selectively apply the needed amount of compensation to the video signal according to the indicated motion.

2. The compensator of claim 1, the compensator being arranged to apply less of the needed compensation where there is less motion, over at least some of the range of possible motions.

3. The compensator of claim 1, comprising a motion detector for generating the indication of motion.

4. The compensator of claim 1, the indication of motion indicating motion per pixel or per group of pixels.

5. The compensator of claim 1, comprising a part for generating the indication of amounts of needed compensation.

6. The compensator of claim 5, the part for generating the indication of amounts of needed compensation comprising a store for storing for each pixel an accumulation of video levels experienced over the life of the display, and for deriving the indication according to the accumulation and according to a model of display output ageing for various accumulations.

7. The compensator of claim 5, the part for generating the indication of amounts of needed compensation comprising an output detector for determining a light output of each pixel, and for generating the indication according to the light output.

8. The compensator of claim 1 having a part for determining a level of spatial variability in a given frame of the incoming video signal and the compensator being arranged to selectively apply the needed amount of compensation to the video signal according to the determined level of spatial variation.

9. The compensator of claim 1, arranged to output a compensated video signal representing each pixel sequentially in time for feeding to a display driver.

10. A display driver circuit having a pixel drive circuit for each pixel, and a compensator of claim 1 for each pixel drive circuit.

11. A display system having a display panel and the compensator of claim 1, or the driver circuit.

12. A method of selectively compensating for age-related non-uniformities in a display, the method having the steps of receiving an indication of motion in an incoming video signal, receiving an indication of amounts of compensation for the different parts of the display needed to compensate for the non-uniformities, and selectively applying the needed amounts of compensation to the video signal according to the indicated motion.

13. A computer program product comprising code segments, which when executed on a processing engine implement any of the methods according to claim 12.

14. A machine readable signal storage medium having the computer program product of claim 13 stored thereon.

15. An integrated circuit having the compensator of claim 1.
